(19) United States
(12) Patent Application Publication
(10) Pub. No.: US 2025/0122017 A1
(43) Pub. Date: Apr. 17, 2025

(54) KITTED GRAVITY ROLLING CONVEYOR SYSTEM

(71) Applicant: GLOBAL INDUSTRIAL DISTRIBUTION INC., Port Washington, NY (US)

(72) Inventors: Richard B. LEEDS, Port Washington, NY (US); Bruce B. ZUTLER, Port Washington, NY (US); Kevin CHOW, Port Washington, NY (US)

(73) Assignee: GLOBAL INDUSTRIAL DISTRIBUTION INC., Port Washington, NY (US)

(21) Appl. No.: 18/914,979

(22) Filed: Oct. 14, 2024

Related U.S. Application Data
(60) Provisional application No. 63/544,110, filed on Oct. 13, 2023.

(51) Int. Cl. B65G 13/11; B65G 13/08

(52) U.S. Cl. CPC B65G 13/11; B65G 13/08; B65G 2207/30

(57) ABSTRACT

The disclosed technology includes a modular conveyor system comprising a plurality of rails and cross-ties extending between pairs of the rails to form a frame. A plurality of rollers is received by the rails to provide a conveyor. One or more H-stands are attached to the rails to support the conveyor system.

### CROSS REFERENCE TO RELATED APPLICATION

The present application claims priority to U.S. Provisional Patent Application No. 63/544,110, filed Oct. 13, 2023. The entire contents of which are hereby incorporated by reference.

### FIELD

The present invention relates generally to a conveyor system for transporting objects, and in particular a kitted gravity rolling conveyor system with components having adjustable lengths, widths, and height.

### BACKGROUND

Gravity roller conveyors, in which a roller conveyor bed is arranged on an incline, are often used to convey pallets or boxes from high levels to lower levels in warehouses. Because gravity-advance conveyors do not require a drive system, they are less complex than powered-roller conveyors. Gravity roller conveyor systems are fast, simple and effective solutions for handling and transporting products in warehouses, shipping departments, and assembly areas. These conveyors are cost efficient and excellent for both permanent and temporary applications.

However, components of gravity roller conveyors typically come in set dimensions making it difficult for adaptation to adapt to different floor layouts and particularly smaller spaces. What is needed, therefore, is a kitted, modular gravity rolling conveyor system able to be easily adapted to available space without extensive rework.

### SUMMARY

There is provided, in accordance with an example of the disclosed technology, a modular conveyor comprising two rails, each rail comprising a sidewall, the sidewall comprising a first plurality of through holes and a second plurality of through holes; at least one cross-tie removably coupled between the two rails by fasteners provided through the first plurality of through holes of each of the two rails; and a plurality of rollers, each roller comprising a first axle end and a second axle end, the first axle end and the second axle end configured to be received by the second plurality of through holes of each of the two rails.

The sidewall of each of the two rails can further comprise a third plurality of through holes, and a channel connector can couple to each rail by fasteners received through the third plurality of through holes to couple to additional rails to extend the length of the modular conveyor. The modular conveyor can further comprise at least one H-stand coupled to the two rails. Each of the two rails can further comprise a bottom wall comprising a fourth plurality of through holes for coupling with the H-stand. The H-stand can comprise two pivot brackets, each pivot bracket comprising a top portion with two or more through holes, the H-stand being coupled to the two rails by fasteners provided through the two or more through holes of the top portion of the two pivot brackets and corresponding through holes of the fourth plurality of through holes.

At least one of the first axle end or the second axle end of each roller can be depressible into a body of the roller. The second plurality of through holes of the two rails can provide for adjustable spacing of the plurality of rollers. A spacing between a center of each roller may be variable between about 3 inches and 6 inches. A spacing between a center of each roller may be selectable between 3 inches, 4.5 inches, and 6 inches.

The disclosed technology can include a H-stand for a modular conveyor system, comprising at least two telescoping uprights; at least two pivot brackets, each pivot bracket provided at the top of each of the two telescoping uprights; and at least two cross-beams coupling the two telescoping uprights. The at least two cross-beams can be telescoping to allow for a width of the H-stand to be varied. Each of the at least two cross-beams can comprise an inner portion and an outer portion, wherein the inner portion is at least partially nested within the outer portion. The inner portion can be coupled to the outer portion by five fasteners. The width of the H-stand can be variable between a 15-inch configuration and a 24-inch configuration. A height of each of the at least two telescoping uprights can be adjustable between about 24 inches and 36 inches. Each of the at least two telescoping uprights can comprise a bottom portion and a top portion, wherein the top portion may be at least partially nested within the bottom portion. The bottom portion may be coupled to the top portion by four fasteners. The four fasteners can also couple the at least two-cross-beams to each of the at least two telescoping uprights.

Each of the at least two pivot brackets can comprise a curved slot hole to provide to provide an adjustable angle between each pivot bracket and each of the at least two telescoping uprights. Each of the at least two telescoping uprights can comprise a baseplate.

The disclosed technology can include a modular curved conveyor comprising an inner rail comprising a sidewall, the side wall comprising a first plurality of through holes and a second plurality of through holes; an outer rail comprising a sidewall, the side wall comprising a first plurality of through holes and a second plurality of through holes; at least one cross-tie removably coupled between the inner rail and the outer rail by fasteners provided through the first plurality of through holes of the inner rail and the first plurality of through holes of the outer rail; and a plurality of rollers, each roller comprising a first axle end and a second axle end, the first axle end configured to be received by the second plurality of through holes of the inner rail, and the second axle end configured to be received by the second plurality of through holes of the outer rail.

The sidewall of the outer rail further can comprise a third plurality of through holes, and the two outer rails can be coupled together by an outer curved channel connector coupled to each of the two outer rails by fasteners received through the third plurality of through holes. The sidewall of the inner rail can further comprise a third plurality of through holes, and the two inner rails can be coupled together by an inner curved channel connector coupled to each of the two inner rails by fasteners received through the third plurality of through holes. A radius of curvature of the inner curved channel connector can be less than a radius of curvature of the outer curved channel connector. A length of the inner curved channel connector can be less than a length of the outer curved channel connector.

The modular curved conveyor can further comprise at least one H-stand coupled to the inner rail and the outer rail. The inner rail can further comprise a bottom wall comprising a fourth plurality of through holes, and the outer rail can further comprise a bottom wall comprising a fourth plurality of through holes for coupling with the H-stand. The H-stand can comprise two pivot brackets, each pivot bracket comprising a top portion with two or more through holes, the H-stand can be coupled to the inner rail and the outer rail by fasteners provided through the two or more through holes of the top portion of the two pivot brackets and corresponding through holes of the fourth plurality of through holes of the inner rail and the fourth plurality of through holes of the outer rail.

The plurality of rollers of the modular curved conveyor can be tapered. At least one of the first axle end or the second axle end of each roller can be depressible into a body of the roller. The second plurality of through holes of the inner rail and the second plurality of through holes of the outer rail can provide for adjustable spacing of the plurality of rollers. A spacing between a center of each roller can be varied between about 3 inches and 6 inches.

The disclosed technology can include a modular conveyor system comprising: a table frame comprising two rails, each rail comprising a sidewall comprising a first plurality of through holes and a second plurality of through holes; and a bottom wall comprising a fourth plurality of through holes; and at least one cross-tie removably coupled between the two rails by fasteners provided through the first plurality of through holes; a plurality of rollers, each roller comprising a first axle end and a second axle end, the first axle end and the second axle end configured to be received by the second plurality of through holes; and a H-stand comprising two uprights coupled together by two cross-beams; and two pivot brackets, each pivot bracket provided at the top of each of the two uprights and comprising a top portion with two or more through holes, the H-stand being coupled to the table frame by fasteners provided through the two or more through holes of the top portion of the two pivot brackets and corresponding through holes of the fourth plurality of through holes of each rail.

The H-stand can comprise two cross-beams. The two cross-beams can be telescoping to provide allow for a width of the H-stand to be varied. Each of the two cross-beams can comprise an inner portion and an outer portion, wherein the inner portion is at least partially nested within the outer portion. The inner portion can be coupled to the outer portion by five fasteners. The width of the H-stand can be varied between a 15-inch configuration and a 24-inch configuration. A height of each of the two uprights can be adjustable between about 24 inches and 36 inches. Each of the two uprights can comprise a bottom portion and a top portion, wherein the top portion is at least partially nested within the bottom portion. Each of the two pivot brackets can comprise a curved slot hole to provide to provide an adjustable angle between each pivot bracket and each of the two uprights.

At least one of the first axle end or the second axle end of each roller can be depressed into a body of the roller. The second plurality of through holes of the two rails can provide for adjustable spacing of the plurality of rollers. A spacing between a center of each roller can variable between about 3 inches and 6 inches. A spacing between a center of each roller can be selected between 3 inches, 4.5 inches, and 6 inches.

The modular conveyor system can further comprise one or more guide rails. Each of the two rails can further comprise a top wall comprising a fifth plurality of through holes, and wherein one or more guide rails are fastened to the two rails by fasteners provided through the fifth plurality of through holes. A width of the at least one cross-tie can be adjusted between about 15 inches and 24 inches. The sidewall of each of the two rails can further comprise a third plurality of through holes, and wherein a channel connector 280 is coupled to each rail by fasteners received through the third plurality of through holes to couple to two additional rails. The table frame formed by coupling the two rails to two additional rails can have a capacity of up to about 1200 pounds without an additional H-stand provided at an intersection between the two rails to two additional rails. The two rails and the two additional rails may each be about 5 feet in length.

### BRIEF DESCRIPTION OF THE DRAWINGS

FIG. 1 is an illustration of an example modular gravity rolling conveyor system, according to aspects of the present invention;

FIG. 2 is an illustration of an example rail component of a modular gravity rolling conveyor system, according to aspects of the present invention;

FIG. 3 is an illustration of an example table frame of a modular gravity rolling conveyor system, according to aspects of the present invention;

FIG. 4 is an illustration of an example table frame with rollers installed of a modular gravity rolling conveyor system, according to aspects of the present invention;

FIG. 5 is an illustration of an example assembled straight conveyor portion of a modular gravity rolling conveyor system, according to aspects of the present invention;

FIG. 6 is a side plan view of an example table frame with rollers installed of a modular gravity rolling conveyor system, according to aspects of the present invention;

FIG. 7 is an illustration of an example assembled straight conveyor portion with H-stands installed of a modular gravity rolling conveyor system, according to aspects of the present invention;

FIG. 8 is an illustration of an example baseplate of a H-stand of a modular gravity rolling conveyor system, according to aspects of the present invention;

FIG. 9A is an illustration of an example H-stand of a modular gravity rolling conveyor system, according to aspects of the present invention;

FIG. 9B is an illustration of an example H-stand of a modular gravity rolling conveyor system, according to aspects of the present invention;

FIG. 9C is an illustration of an example H-stand of a modular gravity rolling conveyor system, according to aspects of the present invention;

FIG. 9D is an illustration of an example H-stand of a modular gravity rolling conveyor system, according to aspects of the present invention;

FIG. 10 is an illustration of an example H-stand installed at the intersection of two assembled straight conveyor portions of a modular gravity rolling conveyor system, according to aspects of the present invention;

FIG. 11A is an illustration of an example channel connector for connecting two rails of a modular gravity rolling conveyor system, according to aspects of the present invention;

FIG. 11B is an illustration of an example channel connector for connecting two rails of a modular gravity rolling conveyor system, according to aspects of the present invention;

FIG. 12 is an illustration of two exemplary rails of a modular gravity rolling conveyor system connected by fastening at the end plates, according to aspects of the present invention;

FIG. 13A is an illustration of an example assembled curved conveyor portion of a modular gravity rolling conveyor system, according to aspects of the present invention;

FIG. 13B is an illustration of an example assembled curved conveyor portion of a modular gravity rolling conveyor system, according to aspects of the present invention;

FIG. 14A is an illustration of an example ball transfer table with an H-stand installed of a modular gravity rolling conveyor system, according to aspects of the present invention;

FIG. 14B is an illustration of an example H-stand installed at the intersection of two ball transfer tables of a modular gravity rolling conveyor system, according to aspects of the present invention;

FIG. 15A is an illustration of an example guide rail installed on a straight conveyor portion a modular gravity rolling conveyor system, according to aspects of the present invention;

FIG. 15B is an illustration of an example angle end stop installed on a straight conveyor portion a modular gravity rolling conveyor system, according to aspects of the present invention; and

FIG. 16 is an example of an example skate wheel conveyor of a modular gravity rolling conveyor system, according to aspects of the present invention.

### DETAILED DESCRIPTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 110%.

As discussed herein, “user” can include operators, maintenance technicians, or any other individuals associated with assembling the kitted gravity roller conveyor system.

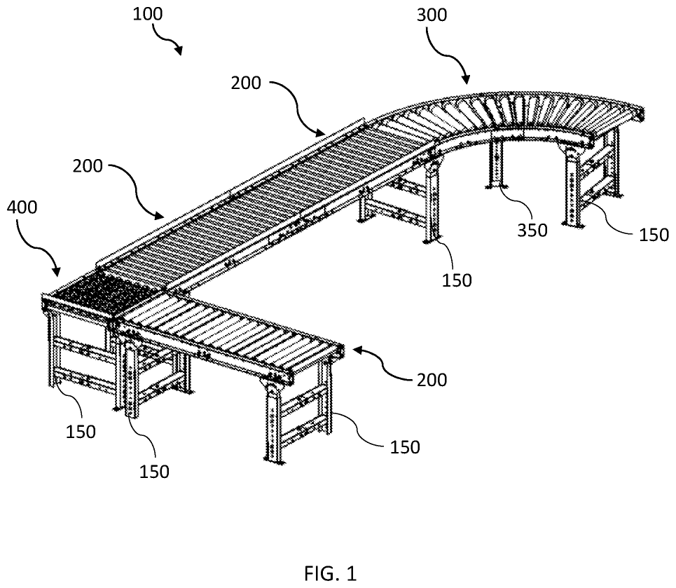

Reference is made to FIG. 1 showing an example modular gravity roller conveyor system 100 which may be kitted, i.e., provided to a user with the necessary components to assemble and customize the modular gravity roller conveyor system 100. The modular gravity roller conveyor system 100 may be herein referred to as the modular conveyor system 100.

In some examples, the modular conveyor system 100 comprises straight conveyors 200, curved conveyors 300, and/or ball transfer tables 400, each of which may be supported by H-stands 150 provided throughout the modular conveyor system 100. As further described herein, the H-stands 150 may be adjustable in height to provide a slope to the modular conveyor system 100 such that objects may be conveyed under the influence of gravity. In some examples, the height of the H-stand may be adjusted from about 15 inches to about 36 inches.

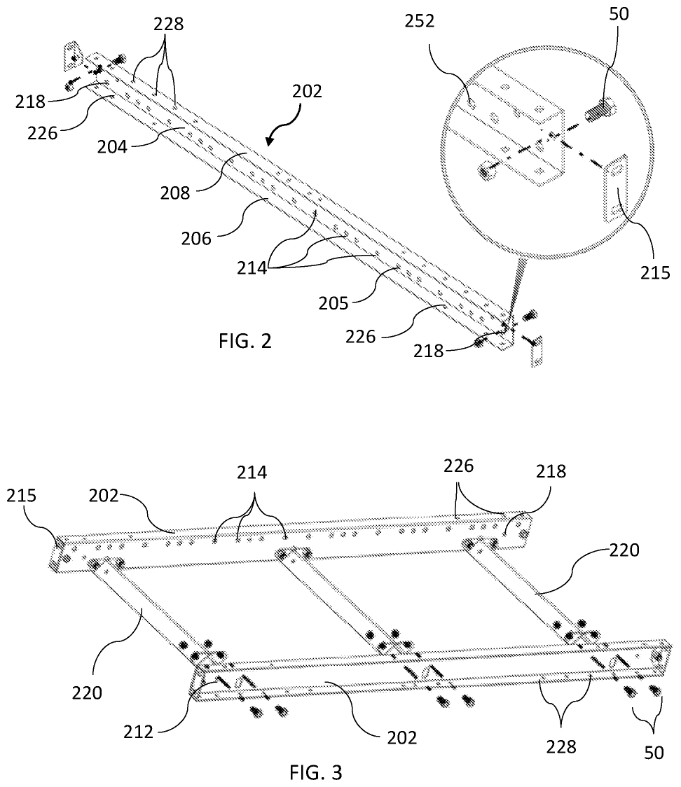

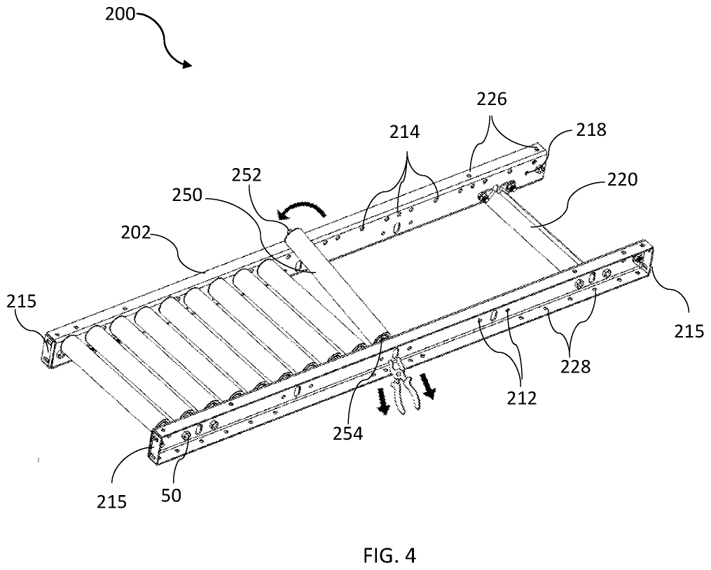

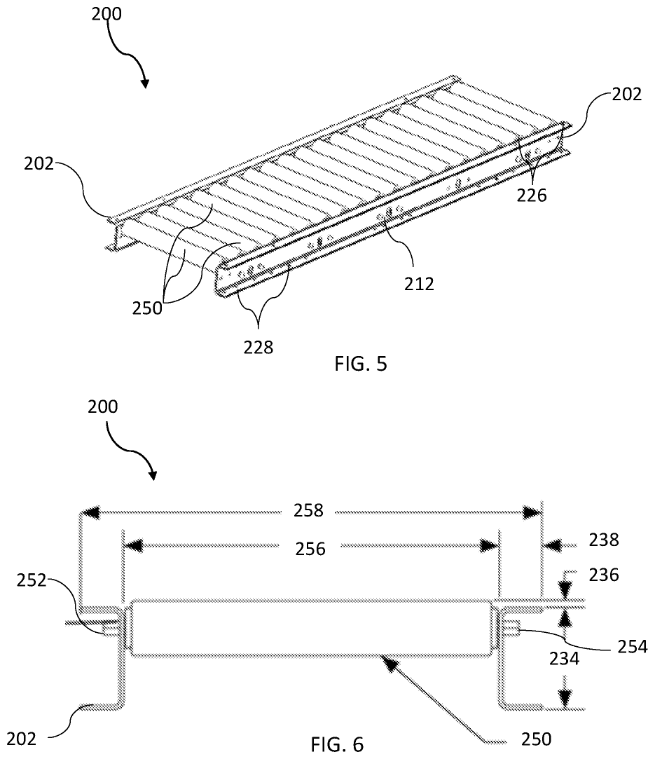

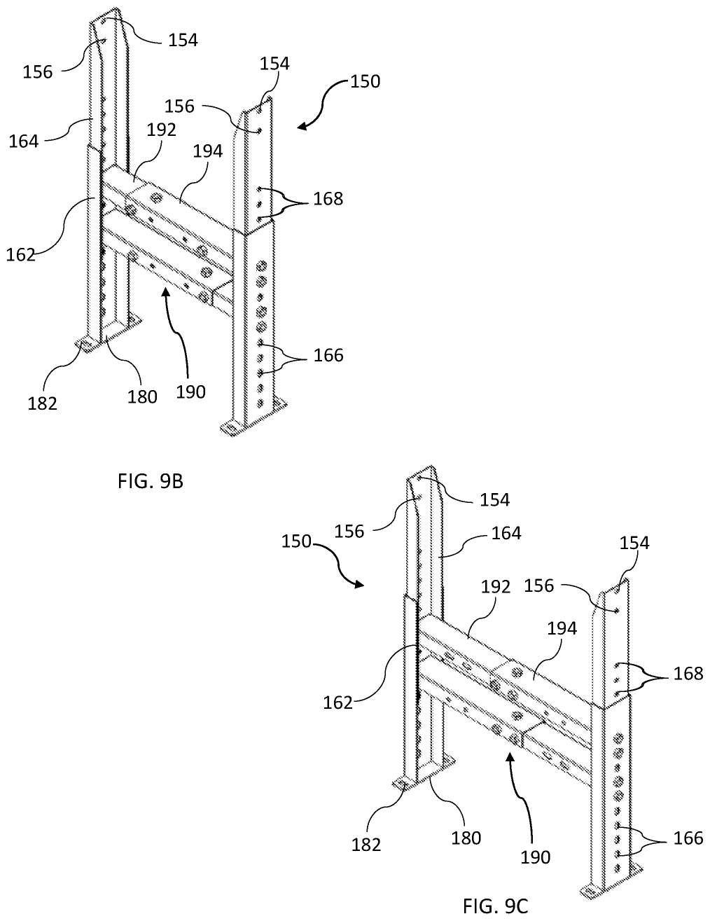

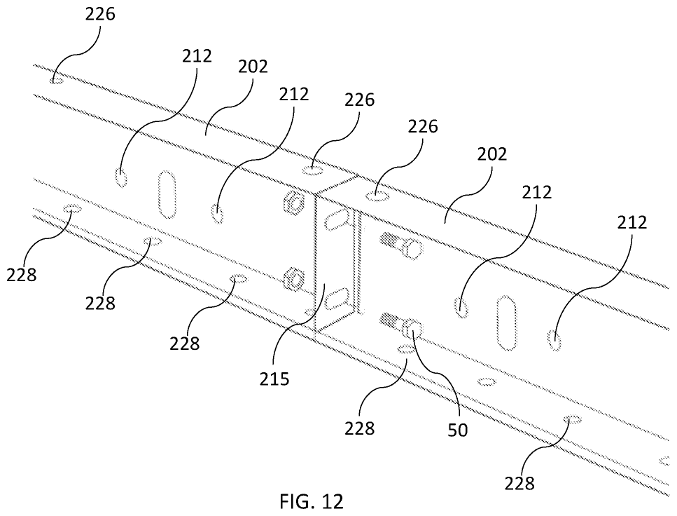

Reference is made to FIG. 2 showing an exemplary rail 202 of a straight conveyor 200. The rail 202 may comprise a c-shape. The rail may comprise a side wall 204, a top wall 206, and a bottom wall 208. In FIG. 2, the rail is illustrated upside down. The rail 202 may comprise a plurality of holes provided through the sidewall 204. A first plurality of through holes 212 may be provided through the sidewall 204 of the rail 202 for coupling of one or more cross-ties (e.g., cross-ties 220 illustrated in FIG. 3). A second plurality of through holes 214 may be provided through the sidewall 204 of the rail 202 to receive a plurality of rollers (e.g., rollers 250 illustrated in FIG. 4). A third plurality of through holes 218 may be provided through the sidewall 204 of the rail 202 for coupling a channel connector (e.g., channel connector 280 illustrated in FIGS. 11A and 11B) or end plate 215. The bottom wall 208 may comprise a fourth plurality of through holes 228 for coupling the rail 202 to an H-stand (e.g., H-stand 150 illustrated in FIG. 7). In an example, the rails 202 comprise 10-gauge steel. In an example, the rails 202 are powder coated.

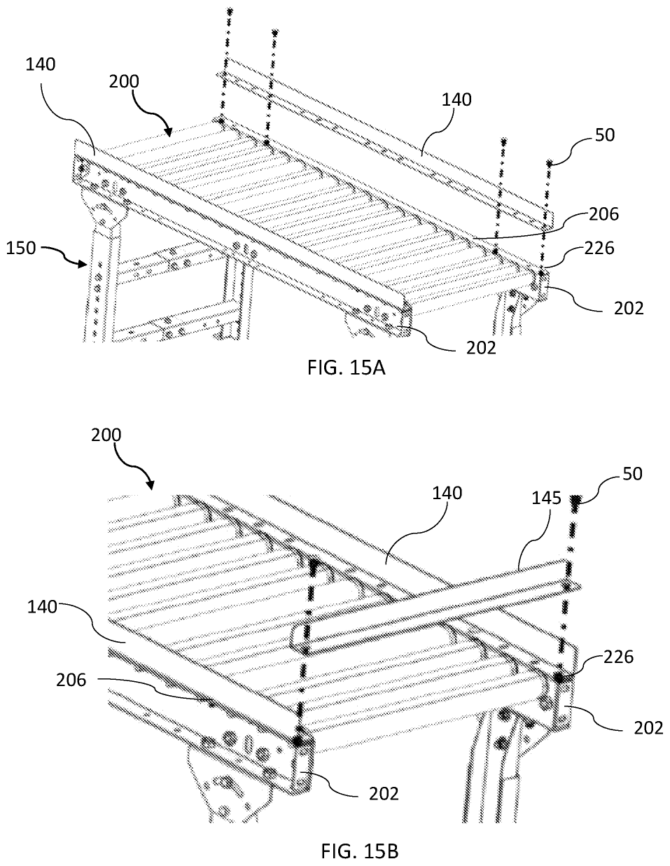

The top wall 206 may comprise a fifth plurality of through holes 226 for coupling a guide rail (e.g., guide rail 140 illustrated in FIG. 15A) or angle end stop the rail 202. As depicted in FIGS. 15A and 15B, rails 202 of a straight conveyor 200 may further comprise a plurality of holes 226 provided in the top wall 206 of the rails 202 to for attachment of guide rails 140 and/or an angle stop 145. One would appreciate, that a plurality of holes in the top walls of the rails of the curved conveyor sections 300, ball transfer tables 400, or skate wheel conveyors 500 could be implemented for attachment of curved guide rails configured for the curved conveyor sections 300 or guide rails configured for the ball transfer tables 400 or skate wheel conveyors 500. In an example, the guide rail and/or angle stop comprise 12-gauge steel. In an example, the guide rail and/or angle stop is powder coated.

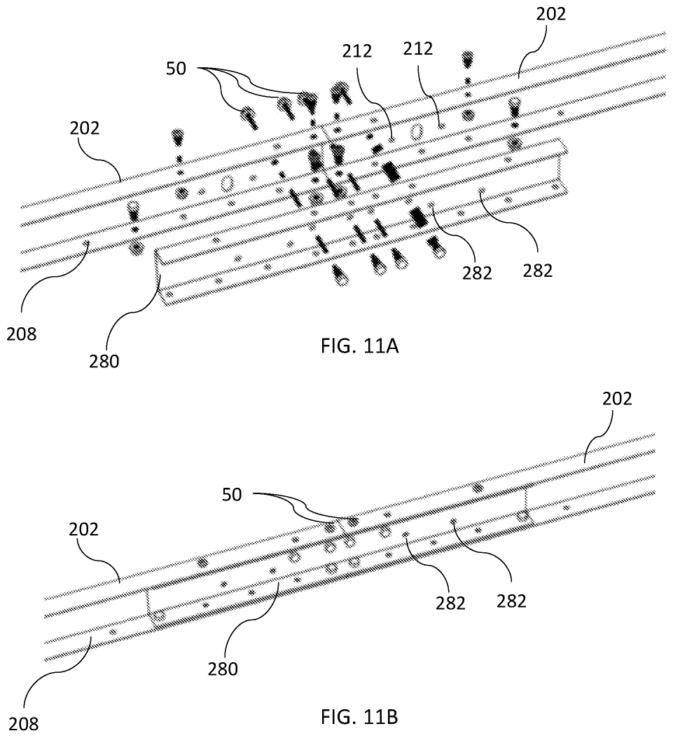

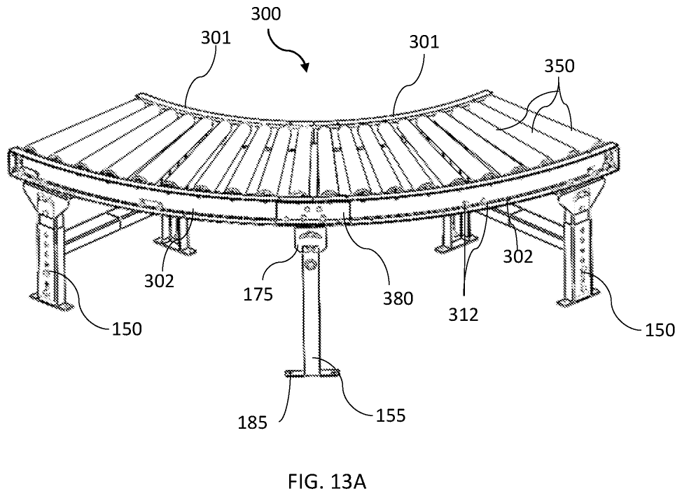

FIG. 2 further depicts fastening of an end plate 215 to the end of the rail 202. The end plate 215 may be fastened to the rail by a fastener 50. As depicted in FIG. 12, the end plates 215 of two rails 202 may be fastened together to create a large segment. In an example, each rail 202 is provided as a five-foot segment, and multiple rails 202 may be fastened together to create a larger segment. For example, two rails 202, each having a length of five feet may be fastened together to form a 10-foot rail. As depicted in FIG. 10, in an example, wherein two rails 202 are fastened together by the end plates 215, an H-stand 150 may be provided at the intersection of the two rails 202 to provide support at the connection point. In an example, wherein a channel connector (e.g., channel connector 280 depicted in FIGS. 11A and 11B) is used to connect two rails 202, an H-stand 150 or other means of support may not be necessary.

The fastener 50 may comprise a nut and corresponding bolt. The term fastener 50 is used herein to refer generally to a nut and bolt or any suitable fastening means, such as, but not limited to rivets, bolts with corresponding threaded apertures, locking pins, etc. While several components herein are referred to as a fastener 50, the term should not be interpreted to require each fastener 50 to be of the same size or type. One would readily recognize a that the fasteners 50 disclosed herein may vary in size, shape, and type to accommodate the various components used in conjunction with said fasteners. Corresponding through holes or apertures configured to receive the fasteners may be sized accordingly. Corresponding through holes configured to receive the fasteners may comprise threading or may be shaped to prevent rotation of the fastener (e.g., provided as a square for corresponding to a square neck bolt).

With reference to FIG. 3, two rails 202 are depicted as being coupled together by cross-ties 220. The connected rails 202 and cross-ties 220 may be collective referred to as a table frame. For a straight conveyor section, rails 202 and cross-ties 220 coupled together may be referred to as a straight table frame. The cross-ties 220 may be coupled to each rail 202 by fasteners 50 provided through the first plurality of through holes 212 of each rail 202 and through corresponding apertures provided in each cross-tie 220. In some examples, the cross-ties 220 may be adjustable such that the width of each cross-tie can be varied to accommodate a 15 inch, an 18-inch, a 21-inch or a 24-inch configuration of the conveyor system. An adjustable cross-tie 220 may comprise a first portion and a second portion, wherein the second portion at least partially nests within the first portion. One or more set screws may be utilized to lock the selected width of the cross-tie 220 into the desired configuration. In some examples, the cross-ties 220 comprise a fixed width. In some examples, the cross-ties are provided with fixed widths for a 15-inch configuration, an 18-inch configuration, a 21-inch configuration, and a 24-inch configuration. In some examples, a cross-tie is provided about 3 inches smaller than the total width of the conveyor section, for example, for an 18-inch configuration a cross-tie of approximately 15 inches may be provided.

With reference to FIG. 4, a straight conveyor 200 is depicted being assembled as rollers 250 are received by the second plurality of through holes 214 of the rails 202. The configuration of the second plurality of through holes 214 allows for spacing between the rollers 250 to be varied. In some examples, the second plurality of through holes 214 allows for a user to select the center-to-center distance between each roller between about 3 inches to 6 inches. In some examples, the second plurality of through holes 214 allows for a user to select the center-to-center distance between each roller to be 3 inches, 4.5 inches, or 6 inches.

In some examples, each roller 250 comprises a first axle end 252 and a second axle end 254. At least one of the first axle end 252 or the second axle end 254 may be depressible into the body of the roller. The depressible axle end may be also referred to as the flexible end and the non-depressible axle end may be referred to as the rigid end. In an example, the second axle end 254 is rigid and is inserted into the second plurality of through holes 214 of one of the rails 202 first, the first axle end 252 is flexible and the roller 250 is rotated into place such that the first axle end is received by a corresponding through hole of the second plurality of through holes 214 of the other rail 202. In some examples, a user pulls the second end with pliers while rotating the roller into place. In an example, the axles are 7/16-inch hex retained axles. In an example, the flexible axle is biased by a spring.

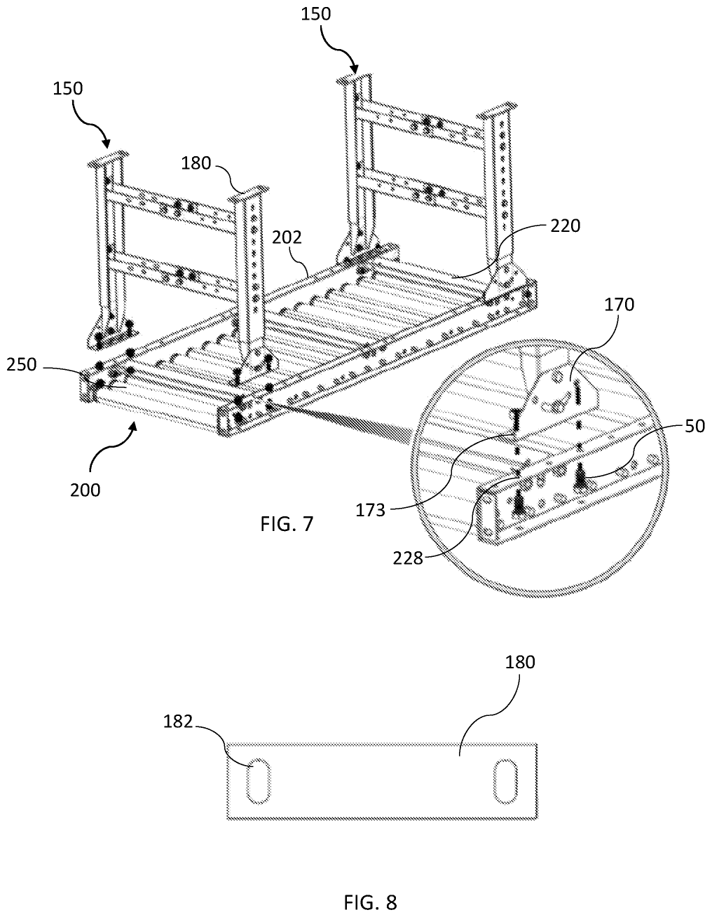

FIG. 5 depicts an example assembled straight conveyor 200 comprising 20 rollers 250. The exemplary straight conveyor 200 depicted in FIG. 5 further comprises 3 cross-ties 220 and has a length of about 5 feet and a center-to-center distance of about 3 inches between each roller 250.

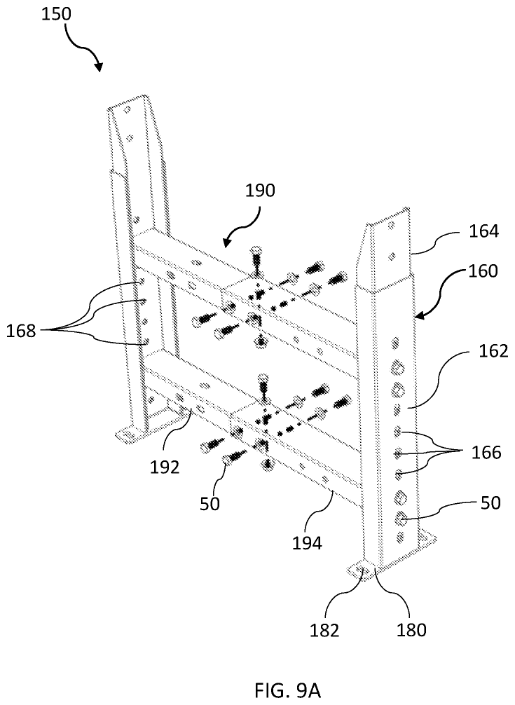

FIG. 6 illustrates a side plan view depicting exemplary dimensions of the rollers 250 and rails 202. In an example, a straight conveyor 200 has an overall width 258 and a width 256 between the rails 202. In an example, when the overall width 258 of the conveyor is about 24 inches, the width 256 between the rails 202 is approximately 21 inches. In an example, when the overall width 258 of the conveyor is about 18 inches, the width 256 between the rails 202 is approximately 15 inches. Since each roller 250 fits between the rails, the width of the roller 250 (excluding the axle ends) is approximately equal to the width 256 between the rails 202. In some examples, the roller has a diameter of 1.9 inches. In some examples, each rail has a height (i.e., a distance from the top wall to the bottom wall) of about 3.5 inches. In some examples, the roller 250 protrudes above the rails 202 by a height 236 of about 0.25 inches. In an example, the body of the rollers comprises a steel tube.

As described herein, components of the conveyor system 100 are designed to be easily adjustable and/or modular to accommodate specific needs. Table 1, provided below, provides exemplary configurations of a straight conveyor 200 and the approximately capacity for each configuration.

TABLE 1
Exemplary Configurations of a Straight Conveyor and Approximate Capacities

| Length | Overall | Between | Roller | # of | # of | Capacity |
|---|---|---|---|---|---|---|
| [Ft] | Width [in.] | Frame (In.) | Centers (In.) | rollers | Cross Ties | (lbs.) |
| 5′ | 18″ | 15″ | 3″ | 20 | 3 | 3300 |
| 5′ | 18″ | 15″ | 4.5″ | 13 | 3 | 2600 |
| 5′ | 18″ | 15″ | 6″ | 10 | 3 | 2000 |
| 5′ | 24″ | 21″ | 3″ | 20 | 3 | 3300 |
| 5′ | 24″ | 21″ | 4.5″ | 13 | 3 | 2600 |
| 5′ | 24″ | 21″ | 6″ | 10 | 3 | 2000 |
| 10′ | 18″ | 15″ | 3″ | 40 | 4 | 1200 |
| 10′ | 18″ | 15″ | 4.5″ | 26 | 4 | 1000 |
| 10′ | 18″ | 15″ | 6″ | 20 | 4 | 800 |
| 10′ | 24″ | 21″ | 3″ | 40 | 4 | 1200 |
| 10′ | 24″ | 21″ | 4.5″ | 26 | 4 | 1000 |
| 10′ | 24″ | 21″ | 6″ | 20 | 4 | 800 |

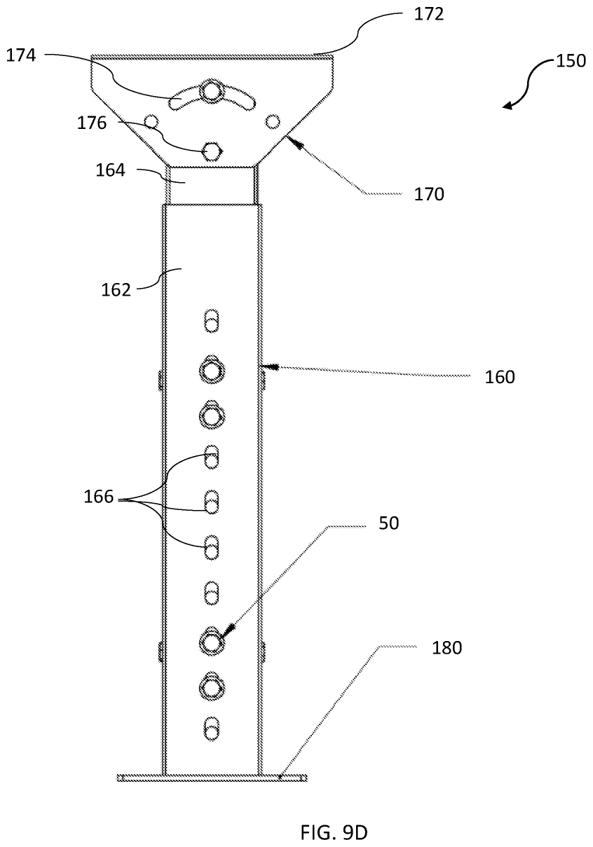

FIG. 7 depicts attachment of two H-stands 150 to a straight conveyor section 200, according to some examples. In some examples, each H-stand 150 comprises two pivot brackets 170. Each pivot bracket 170 may be adjustable to accommodate for the slope of the conveyor system. Each pivot bracket 170 may comprises a top portion 172 having at least two through holes 173 such that fasteners 50 may be provided through the though holes 173 of the pivot brackets 170 and through the fourth plurality of through holes (228) provided through a bottom wall of each rail (202) to attach the H-stands 150 to the rails 202. In some examples, as depicted in FIG. 8, each H-stand 150 may comprise a baseplate 180. The baseplate 180 may comprise at least two lag holes 182 for securing the H-stand 150 to a floor. In an example, the base plate is about 6.25 inches long and 1.5 inches wide. The lag holes 182 of the baseplate 180 may be about 7/16 inches (0.4375″) wide, ⅞ inches (0.875″) long, and provided ⅝ inches (0.625″) from the ends of the baseplate 180.

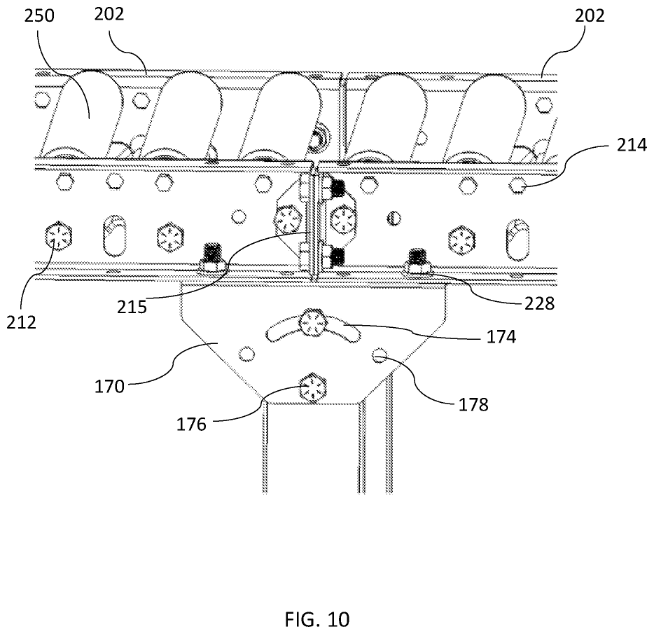

FIGS. 9A-9D depict further details of an exemplary H-stand 150. In some examples, each H-stand 150 comprises at least two uprights 160. The two uprights 160 may be telescoping, thereby providing the H-stand 150 with an adjustable height. Each upright 160 may comprise a top portion 164 and a bottom portion 162. The top portion 164 may be nestable inside the bottom portion 162 to allow for a reduced size/profile.

A pivot bracket 170 may be provided at the top of each the two uprights 160. The pivot bracket 170 may be coupled to a top portion 164 of the upright 160. The pivot bracket 170 may be coupled to a top portion 164 of the upright 160 by a first fastener provided through a hole 176 of the pivot bracket 170 and through a corresponding hole 156 provided in the top portion 164 of the upright 160. A second fastener may be provided through a curved slot hole 174 of the pivot bracket and though a corresponding hole 154 provided in the top portion 164 of the upright 160. The curved slot hole 174 may allow for the angle of the pivot bracket 170 to be adjusted relative to the upright 160 to accommodate the slope of the conveyor system 100.

In some examples, the H-stand 150 comprises at least cross-beam 190 coupling the two uprights 160. In some examples, the H-stand comprise two cross-beams 190. The cross-beams 190 may be telescoping to configured to allow for a width of the H-stand to be varied. The width of the H-stand may be varied to accommodate for a 15-inch to about a 24-inch configuration of the conveyor system 100. In some examples, each cross beam 190 comprises an inner portion 192 and an outer portion 194. The inner portion 192 may nest within the outer portion 194. The inner portion 192 may be fastened to the outer portion 194 by fasteners provided through corresponding though holes provided in the inner portion 192 and outer portion 194 to set the length of the cross-beam 190. In an example, the inner portion 192 is coupled to the outer portion 194 by five fasteners 50.

In some embodiments, the cross-beams 190 are fastened to the uprights 160 by fasteners 50 provided through holes 166 of the bottom portion 162 of the uprights 160 and holes 168 of the top portion 164 of the uprights 160. In some embodiments, a lower cross-beam is welded to the bottom portion 162 of the uprights and a top cross-beam is welded to a top portion 164 of the uprights. In some examples, the inner portions 192 and outer portions 194 are provided on the same side (as depicted in FIG. 9A). In some examples, the inner portions 192 and outer portions 194 are provided on alternate sides (as depicted in FIGS. 9B and 9C).

The height of the H-stand 150 may be adjustable. In some examples, fasteners 50 are provided through holes 166 of the bottom portion 162 of the uprights 160 and holes 168 of the top portion 164 of the uprights 160 to set the height of the H-stand 150. The height of each upright 160 may be adjustable between about 15 inches to about 36 inches. In some embodiments, fasteners 50 provided through the holes 166 of the bottom portion 162 and holes 168 of the top portion 164 also secure the cross-beams 190 to the uprights 160. In some examples, the bottom portion 162 of the upright 160 is coupled to the top portion 164 by four fasteners 50. In an example, the H-stands comprise 12-gauge steel. In an example, the H-stands are powder coated.

As depicted in FIGS. 11A and 11B, a channel connector 280 may be utilized to connect two rails 202. Such a connection may allow, for example, a 10-foot segment to be built from connecting two 5-foot rails. The channel connector 280 may allow for the connection of two rails 202 without the need to provide a H-stand at the intersection of the two rails 202. In contrast, as depicted in FIG. 12, connecting two rails 202 by an end plate 215 may require an H-stand 150 to be provided at the intersection of the two rails 202 to provide proper support. Turning back to FIGS. 11A and 11B, the channel connector 280 may comprise a substantially C-shaped body so as to be nested within the rails 202. The channel connector 280 may comprise a plurality of through holes 282 which correspond with the through holes provided in the rails 202. In an example, the channel connectors comprise steel. In an example, the channel connectors comprise 10-gauge steel.

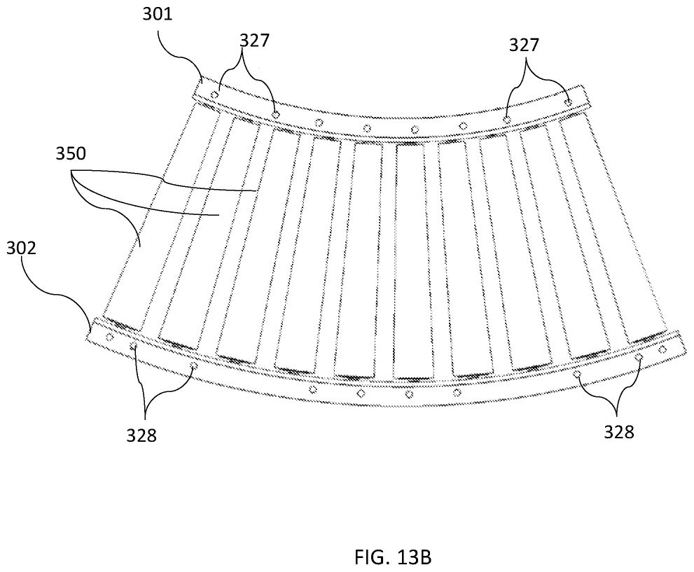

FIGS. 13A and 13B depict a curved conveyor 300, according to some examples. A curved conveyor 300 may comprise inner rails 301 and outer rails 302. For a curved conveyor section, the rails and cross-ties coupled together may be referred to as a curved table frame. In some examples, outer rails 302 comprise a greater length and radius of curvature than inner rails 301. Inner rail 301 may comprise a sidewall with a first plurality of through holes and outer rail 302 may also comprise a sidewall 304 with a first plurality of through holes 312. Cross-ties (e.g., cross-ties 220 depicted in FIGS. 3 and 4) may be fastened to the inner rail 301 and the outer rail 302. The configuration may allow for the same cross-ties 220 to be utilized in both the straight conveyor 200 and the curved conveyor 300 sections. In an example, the rails 302 comprise 10-gauge steel. In an example, the rails 302 are powder coated.

The sidewalls of both the inner rails 301 and the outer rails 302 may each comprise second plurality of through holes to receive a plurality of rollers 350. The rollers 350 of the curved section may be tapered toward the inner rails 301to facilitate conveyance of an object through the curved section. Each roller 350 may comprise a first axle end and a second axle end. In some examples, each of the rollers 350 comprises first axle end and a second axle end. In some examples, at least one of the first axle end or the second axle end of each roller 350 is depressible into a body of the roller. The second plurality of through holes of the inner rail 301 and the second plurality of through holes of the outer rail 302 may provide for adjustable spacing of the plurality of rollers 350. In some examples, the spacing between a center of each roller 350 is variable between about 3 inches and 6 inches. In some examples, the spacing between a center of each roller 350 is selectable between about 3 inches, 4.5 inches, and 6 inches.

As depicted in FIG. 13B, an outer curved channel connector 380 may be used to connect two outer rails 302. An inner curved channel connector (not shown) may be used to connect two inner rails 301. The sidewall of the outer rails 302 may further comprise a third plurality of through holes to receive fasteners for coupling the outer curved channel connector 380. The sidewall of the inner rails 301 may further comprise a third plurality of through holes to receive fasteners for coupling an inner curved channel connector. The radius and length of the inner curved channel connector may be less than the radius and length of the outer curved channel connector. Use of the inner and outer curved channel connectors may negate the need for a support where two curved conveyor sections 300 intersect. In some examples, a single sided support 155 may be coupled to the outside rails 302 where the two outside rails 302 meet. The single sided support 155 may comprise a pivot bracket 175 with an adjustable angle to accommodate for a slope of the conveyor system. The single sided support 155 may comprise a base plate 185 for securing the support 155 to a floor.

The inner rails 301 may comprise holes 327 and the outer rails 302 may comprise holes 328 for the attachment of a H-stand 150. The holes 327 of the inner rails 301 and the holes 328 of the outer rails 302 are spaced such that a H-stand 150 may be used in both the straight conveyor sections 200 and the curved conveyor sections 300.

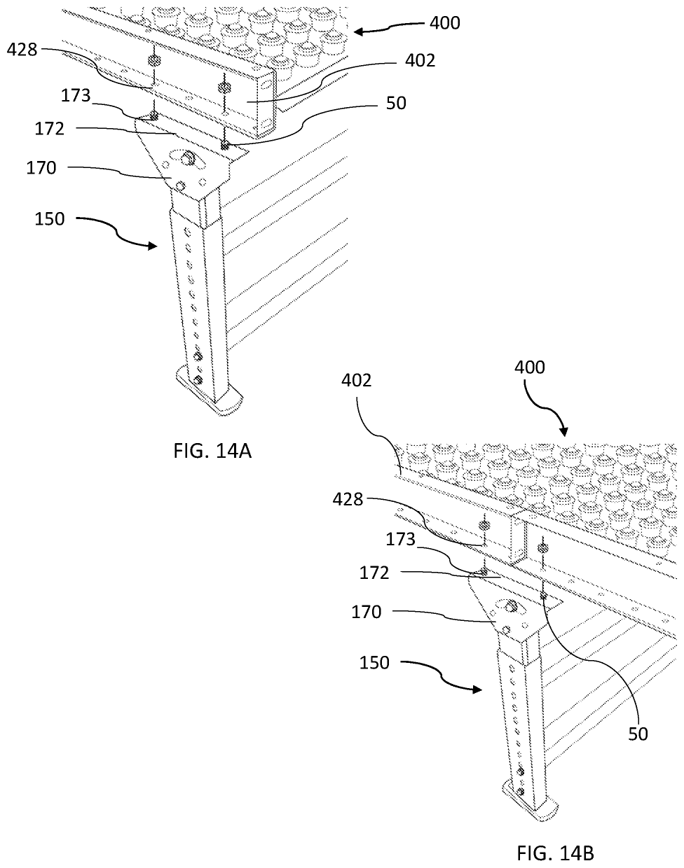

As depicted in FIGS. 14A and 14B, the H-stands 150 may also be utilized to support a ball transfer table 400. The ball transfer table 400 may comprise rails 402 having a plurality of through holes 428 provided on a bottom wall of the rails 402. Fasteners 170 may be provided through holes 173 of the pivot bracket 170 of the H-stand 150 and through holes 428 of the rails 402 of the ball transfer table 400 to attach the H-stand to a ball transfer table 400. As depicted in FIG. 14B, an H-stand 150 may be attached at the intersection of two ball transfer tables 400 to provide necessary support for the tables.

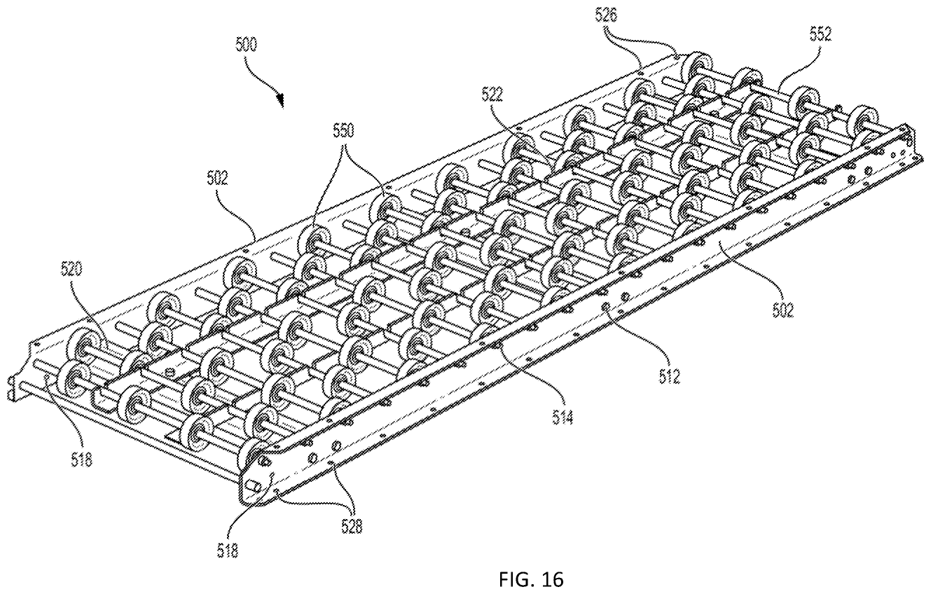

An assembled skate wheel conveyor 500 is depicted in FIG. 16 with a plurality of skate wheels 550 provided between rails 502, according to some examples. The rails 502 may comprise a plurality of holes provided through the sidewalls of the rail. A first plurality of through holes 512 may be provided through the sidewall of the rails 502 for coupling of one or more cross-ties 520. A set of skate wheels 550 may be provided on a rod 552. The ends of the rods 552 may be received by a second plurality of through holes 514 of the rails 502. Middle portions of the rods 552 may be supported by longitudinal supports 522 coupled to the cross-ties 520. The middle portion of the rods 552 may be disposed within notches provided along the length of the longitudinal supports 522.

A third plurality of through holes 518 may be provided through the sidewalls of the rails 502 for coupling a channel connector (e.g., channel connector 280 illustrated in FIGS. 11A and 11B) or end plate. The bottom wall of the rails 502 may comprise a fourth plurality of through holes 528 for coupling the rail 502 to an H-stand (e.g., H-stand 150 illustrated in FIG. 7). The skate wheel conveyor section 500 may be shipped in pre-assembled. The skate wheel conveyor 500 may be provided in varying widths, for example, 15 inches, 18 inches, 21 inches, or 24 inches. In some examples, the a skate wheel conveyor section comprise a length of about 5 feet.

Examples of the present disclosure can be implemented by any of the following numbered clauses:

Clause 1: A modular conveyor (200) comprising: two rails (202), each rail (202) comprising a sidewall (204), the side wall (204) comprising a first plurality of through holes (212) and a second plurality of through holes (214); at least one cross-tie (220) removably coupled between the two rails (202) by fasteners (50) provided through the first plurality of through holes (212) of each of the two rails (202); and a plurality of rollers (250), each roller (250) comprising a first axle end (252) and a second axle end (254), the first axle end (252) and the second axle end (254) configured to be received by the second plurality of through holes (214) of each of the two rails (302).

Clause 2: The modular conveyor (200) of Clause 1, wherein the sidewall (204) of each of the two rails (202) further comprises a third plurality of through holes (218), and wherein a channel connector (280) is coupled to each rail (202) by fasteners (50) received through the third plurality of through holes (218) to couple to additional rails to extend the length of the modular conveyor.

Clause 3: The modular conveyor (200) of Clause 1, further comprising at least one H-stand (150) coupled to the two rails (202).

Clause 4: The modular conveyor (200) of Clause 3, wherein each of the two rails (202) further comprise a bottom wall (208) comprising a fourth plurality of through holes (228) for coupling with the H-stand (150).

Clause 5: The modular conveyor (200) of Clause 4, wherein the H-stand (150) comprises two pivot brackets (170), each pivot bracket (170) comprising a top portion (172) with two or more through holes (173), the H-stand (150) being coupled to the two rails (202) by fasteners (50) provided through the two or more through holes (173) of the top portion (172) of the two pivot brackets (170) and corresponding through holes of the fourth plurality of through holes (228).

Clause 6: The modular conveyor (200) of Clause 1, wherein at least one of the first axle end (252) or the second axle end (254) of each roller (250) is depressible into a body of the roller.

Clause 7: The modular conveyor (200) of Clause 1, wherein the second plurality of through holes (214) of the two rails (202) provide for adjustable spacing of the plurality of rollers (250).

Clause 8: The modular conveyor (200) of Clause 7, wherein a spacing between a center of each roller (250) is variable between about 3 inches and 6 inches.

Clause 9: The modular conveyor (200) of Clause 7, wherein a spacing between a center of each roller (250) is selectable between 3 inches, 4.5 inches, and 6 inches.

Clause 10: A H-stand (150) for a modular conveyor system (100), comprising: at least two telescoping uprights (160); at least two pivot brackets (170), each pivot bracket (170) provided at the top of each of the two telescoping uprights (160); and at least two cross-beams (190) coupling the two telescoping uprights (160).

Clause 11: The H-stand (150) of Clause 10, wherein the at least two cross-beams (190) are telescoping to allow for a width of the H-stand to be varied.

Clause 12: The H-stand (150) of Clause 11, wherein each of the at least two cross-beams (190) comprises an inner portion (192) and an outer portion (194), wherein the inner portion (192) is at least partially nested within the outer portion (194).

Clause 13: The H-stand (150) of Clause 12, wherein the inner portion (192) is coupled to the outer portion (194) by five fasteners (50).

Clause 14: The H-stand (150) of Clause 11, wherein the width of the H-stand is variable between a 15-inch configuration and a 24-inch configuration.

Clause 15: The H-stand (150) of Clause 10, wherein a height of each of the at least two telescoping uprights (160) is adjustable between about 24 inches and 36 inches.

Clause 16: The H-stand (150) of Clause 10, wherein each of the at least two telescoping uprights (160) comprise a bottom portion (162) and a top portion (164), wherein the top portion (164) is at least partially nested within the bottom portion (162).

Clause 17: The H-stand (150) of Clause 16, wherein the bottom portion (162) is coupled to the top portion (164) by four fasteners (50).

Clause 18: The H-stand (150) of Clause 17, wherein the four fasteners (50) also couple the at least two cross-beams (190) to each of the at least two telescoping uprights (160).

Clause 19: The H-stand (150) of Clause 10, wherein each of the at least two pivot brackets (170) comprises a curved slot hole (174) to provide an adjustable angle between each pivot bracket (170) and each of the at least two telescoping uprights (160).

Clause 20: The H-stand (150) of Clause 10, wherein each of the at least two telescoping uprights (160) comprises a baseplate (180).

Clause 21: A modular curved conveyor (300) comprising: an inner rail (301) comprising a sidewall (303), the side wall (303) comprising a first plurality of through holes (311) and a second plurality of through holes (313); an outer rail (302) comprising a sidewall (304), the side wall (304) comprising a first plurality of through holes (312) and a second plurality of through holes (314); at least one cross-tie (220) removably coupled between the inner rail (301) and the outer rail (302) by fasteners (50) provided through the first plurality of through holes (311) of the inner rail (301) and the first plurality of through holes (312) of the outer rail (302); and a plurality of rollers (350), each roller (350) comprising a first axle end (352) and a second axle end (354), the first axle end (352) configured to be received by the second plurality of through holes (313) of the inner rail (301), and the second axle end (354) configured to be received by the second plurality of through holes (314) of the outer rail (302).

Clause 22: The modular curved conveyor (300) of Clause 21, wherein the sidewall (304) of the outer rail (302) further comprises a third plurality of through holes (318), and wherein two outer rails (302) are coupled together by an outer curved channel connector (380) coupled to each of the two outer rails (302) by fasteners (50) received through the third plurality of through holes (318).

Clause 23: The modular curved conveyor (300) of Clause 22, wherein the sidewall (303) of the inner rail (301) further comprises a third plurality of through holes (317), and wherein two inner rails (301) are coupled together by an inner curved channel connector (381) coupled to each of the two inner rails (301) by fasteners (50) received through the third plurality of through holes (317).

Clause 24: The modular curved conveyor (300) of Clause 23, wherein a radius of curvature of the inner curved channel connector (381) is less than a radius of curvature of the outer curved channel connector (380).

Clause 25: The modular curved conveyor (300) of Clause 23, wherein a length of the inner curved channel connector (381) is less than a length of the outer curved channel connector (380).

Clause 26: The modular curved conveyor (300) of Clause 21, further comprising at least one H-stand (150) coupled to the inner rail (301) and the outer rail (302).

Clause 27: The modular curved conveyor (300) of Clause 26, wherein the inner rail (301) further comprises a bottom wall (307) comprising a fourth plurality of through holes (327), and wherein the outer rail (302) further comprises a bottom wall (308) comprising a fourth plurality of through holes (328) for coupling with the H-stand (150).

Clause 28: The modular curved conveyor (300) of Clause 27, wherein the H-stand (150) comprises two pivot brackets (170), each pivot bracket (170) comprising a top portion (172) with two or more through holes (173), the H-stand (150) being coupled to the inner rail (301) and the outer rail (302) by fasteners (50) provided through the two or more through holes (173) of the top portion (172) of the two pivot brackets (170) and corresponding through holes of the fourth plurality of through holes (327) of the inner rail (301) and the fourth plurality of through holes (328) of the outer rail (302).

Clause 29: The modular curved conveyor (300) of Clause 21, wherein each roller (350) of the plurality of rollers (350) is tapered.

Clause 30: The modular curved conveyor (300) of Clause 21, wherein at least one of the first axle end (352) or the second axle end (354) of each roller (350) is depressible into a body of the roller.

Clause 31: The modular curved conveyor (300) of Clause 21, wherein the second plurality of through holes (313) of the inner rail (301) and the second plurality of through holes (314) of the outer rail (302) provide for adjustable spacing of the plurality of rollers (350).

Clause 32: The modular curved conveyor (300) of Clause 31, wherein a spacing between a center of each roller (350) is variable between about 3 inches and 6 inches.

Clause 33: A modular conveyor system (100) comprising: a table frame (200) comprising: two rails (202), each rail (202) comprising: a sidewall (204) comprising a first plurality of through holes (212) and a second plurality of through holes (214); and a bottom wall (208) comprising a fourth plurality of through holes (228); and at least one cross-tic (220) removably coupled between the two rails (202) by fasteners (50) provided through the first plurality of through holes (212); a plurality of rollers (250), each roller (250) comprising a first axle end (252) and a second axle end (254), the first axle end (252) and the second axle end (254) configured to be received by the second plurality of through holes (214); and a H-stand (150) comprising: two uprights (160) coupled together by two cross-beams (190); and two pivot brackets (170), each pivot bracket (170) provided at the top of each of the two uprights (160) and comprising a top portion (172) with two or more through holes (173), the H-stand (150) being coupled to the table frame (200) by fasteners (50) provided through the two or more through holes (173) of the top portion (172) of the two pivot brackets (170) and corresponding through holes of the fourth plurality of through holes (228) of each rail (202).

Clause 34: The modular conveyor system (100) of Clause 33, wherein the H-stand (150) comprises two cross-beams (190).

Clause 35: The modular conveyor system (100) of Clause 34, wherein the two cross-beams are telescoping to allow for a width of the H-stand to be varied.

Clause 36: The modular conveyor system (100) of Clause 33, wherein each of the two cross-beams (190) comprises an inner portion (192) and an outer portion (194), wherein the inner portion (192) is at least partially nested within the outer portion (194).

Clause 37: The modular conveyor system (100) of Clause 36, wherein the inner portion (192) is coupled to the outer portion (194) by five fasteners (50).

Clause 38: The modular conveyor system (100) of Clause 35, wherein the width of the H-stand is variable between a 15-inch configuration and a 24-inch configuration.

Clause 39: The modular conveyor system (100) of Clause 33, wherein a height of each of the two uprights (160) is adjustable between about 24 inches and 36 inches.

Clause 40: The modular conveyor system (100) of Clause 33, wherein each of the two uprights (160) comprise a bottom portion (162) and a top portion (164), wherein the top portion (164) is at least partially nested within the bottom portion (162).

Clause 41: The modular conveyor system (100) of Clause 33, wherein each of the two pivot brackets (170) comprises a curved slot hole (174) to provide an adjustable angle between each pivot bracket (170) and each of the two uprights (160).

Clause 42: The modular conveyor system (100) of Clause 33, wherein at least one of the first axle end (252) or the second axle end (254) of each roller (250) is depressible into a body of the roller.

Clause 43: The modular conveyor system (100) of Clause 33, wherein the second plurality of through holes (214) of the two rails (202) provide for adjustable spacing of the plurality of rollers (250).

Clause 44: The modular conveyor system (100) of Clause 43, wherein a spacing between a center of each roller (250) is variable between about 3 inches and 6 inches.

Clause 45: The modular conveyor system (100) of Clause 43, wherein a spacing between a center of each roller (250) is selectable between 3 inches, 4.5 inches, and 6 inches.

Clause 46: The modular conveyor system (100) of any one of Clause 33, further comprising one or more guide rails (140).

Clause 47: The modular conveyor system (100) of Clause 46, wherein each of the two rails (202) further comprise a top wall (206) comprising a fifth plurality of through holes (226), and wherein one or more guide rails are fastened to the two rails (202) by fasteners (50) provided through the fifth plurality of through holes (226).

Clause 48: The modular conveyor system (100) of Clause 33, wherein a width of the at least one cross-tie (220) is adjustable between about 15 inches and 24 inches.

Clause 49: The modular conveyor system (100) of Clause 33, wherein the sidewall (204) of each of the two rails (202) further comprises a third plurality of through holes (218), and wherein a channel connector (280) is coupled to each rail (202) by fasteners (50) received through the third plurality of through holes (218) to couple to two additional rails (202).

Clause 50: The modular conveyor system (100) of Clause 49, wherein the table frame (200) formed by coupling the two rails (202) to two additional rails (202) has a capacity of up to about 1200 pounds without an additional H-stand provided at an intersection between the two rails (202) to two additional rails (202).

Clause 51: The modular conveyor system (100) of Clause 49, wherein the two rails (202) and two additional rails (202) are each about 5 feet in length.

The embodiments described above are cited by way of example, and the present invention is not limited by what has been particularly shown and described hereinabove. Rather, the scope of the invention includes both combinations and sub combinations of the various features described hereinabove, as well as variations and modifications thereof which would occur to persons skilled in the art upon reading the foregoing description and which are not disclosed in the prior art.

What is claimed is:

1. A modular conveyor comprising:
two rails, each rail comprising a sidewall, the sidewall comprising a first plurality of through holes and a second plurality of through holes;
at least one cross-tie removably coupled between the two rails by fasteners provided through the first plurality of through holes of each of the two rails; and
a plurality of rollers, each roller comprising a first axle end and a second axle end, the first axle end and the second axle end configured to be received by the second plurality of through holes of each of the two rails.

2. The modular conveyor of claim 1, wherein the sidewall of each of the two rails further comprises a third plurality of through holes, and wherein a channel connector is coupled to each rail by fasteners received through the third plurality of through holes to couple to additional rails to extend the length of the modular conveyor.

3. The modular conveyor of claim 1, further comprising at least one H-stand coupled to the two rails.

4. The modular conveyor of claim 3, wherein each of the two rails further comprises a bottom wall comprising a fourth plurality of through holes for coupling with the H-stand.

5. The modular conveyor of claim 4, wherein the H-stand comprises two pivot brackets, each pivot bracket comprising a top portion with two or more through holes, the H-stand being coupled to the two rails by fasteners provided through the two or more through holes of the top portion of the two pivot brackets and corresponding through holes of the fourth plurality of through holes.

6. The modular conveyor of any one of claim 1, wherein at least one of the first axle end or the second axle end of each roller is depressible into a body of the roller.

7. The modular conveyor of any one of claim 1, wherein the second plurality of through holes of the two rails provide for adjustable spacing of the plurality of rollers.

8. The modular conveyor of claim 7, wherein a spacing between a center of each roller is variable between about 3 inches and 6 inches.

9. The modular conveyor of claim 7, wherein a spacing between a center of each roller is selectable between 3 inches, 4.5 inches, and 6 inches.

10. A H-stand for a modular conveyor system, comprising:
at least two telescoping uprights;
at least two pivot brackets, each pivot bracket provided at the top of each of the two telescoping uprights; and
at least two cross-beams coupling the two telescoping uprights.

11. The H-stand of claim 10, wherein the at least two cross-beams are telescoping to allow for a width of the H-stand to be varied.

12. The H-stand of claim 11, wherein each of the at least two cross-beams comprises an inner portion and an outer portion, wherein the inner portion is at least partially nested within the outer portion.

13. The H-stand of claim 12, wherein the inner portion is coupled to the outer portion by five fasteners.

14. The H-stand of claim 11, wherein the width of the H-stand is variable between a 15-inch configuration and a 24-inch configuration.

15. The H-stand of claim 10, wherein a height of each of the at least two telescoping uprights is adjustable between about 24 inches and 36 inches.

16. The H-stand of claim 10, wherein each of the at least two telescoping uprights comprises a bottom portion and a top portion, wherein the top portion is at least partially nested within the bottom portion.

17. The H-stand of claim 16, wherein the bottom portion is coupled to the top portion by four fasteners.

18. The H-stand of claim 17, wherein the four fasteners also couple the at least two cross-beams to each of the at least two telescoping uprights.

19. The H-stand of claim 10, wherein each of the at least two pivot brackets comprises a curved slot hole to provide an adjustable angle between each pivot bracket and each of the at least two telescoping uprights.

20. The H-stand of claim 10, wherein each of the at least two telescoping uprights comprises a baseplate.

21. A modular curved conveyor comprising:
an inner rail comprising a sidewall, the sidewall comprising a first plurality of through holes and a second plurality of through holes;
an outer rail comprising a sidewall, the sidewall comprising a first plurality of through holes and a second plurality of through holes;
at least one cross-tie removably coupled between the inner rail and the outer rail by fasteners provided through the first plurality of through holes of the inner rail and the first plurality of through holes of the outer rail; and
a plurality of rollers, each roller comprising a first axle end and a second axle end, the first axle end configured to be received by the second plurality of through holes of the inner rail, and the second axle end configured to be received by the second plurality of through holes of the outer rail.

22. The modular curved conveyor of claim 21, wherein the sidewall of the outer rail further comprises a third plurality of through holes, and wherein two outer rails are coupled together by an outer curved channel connector coupled to each of the two outer rails by fasteners received through the third plurality of through holes.

23. The modular curved conveyor of claim 22, wherein the sidewall of the inner rail further comprises a third plurality of through holes, and wherein two inner rails are coupled together by an inner curved channel connector coupled to each of the two inner rails by fasteners received through the third plurality of through holes.

24. The modular curved conveyor of claim 23, wherein a radius of curvature of the inner curved channel connector is less than a radius of curvature of the outer curved channel connector.

25. The modular curved conveyor of claim 23, wherein a length of the inner curved channel connector is less than a length of the outer curved channel connector.

26. The modular curved conveyor of claim 21, further comprising at least one H-stand coupled to the inner rail and the outer rail.

27. The modular curved conveyor of claim 26, wherein the inner rail further comprises a bottom wall comprising a fourth plurality of through holes, and wherein the outer rail further comprises a bottom wall comprising a fourth plurality of through holes for coupling with the H-stand.

28. The modular curved conveyor of claim 27, wherein the H-stand comprises two pivot brackets, each pivot bracket comprising a top portion with two or more through holes, the H-stand being coupled to the inner rail and the outer rail by fasteners provided through the two or more through holes of the top portion of the two pivot brackets and corresponding through holes of the fourth plurality of through holes of the inner rail and the fourth plurality of through holes of the outer rail.

29. The modular curved conveyor of claim 21, wherein each roller of the plurality of rollers is tapered.

30. The modular curved conveyor of claim 21, wherein at least one of the first axle end or the second axle end of each roller is depressible into a body of the roller.

31. The modular curved conveyor of claim 21, wherein the second plurality of through holes of the inner rail and the second plurality of through holes of the outer rail provide for adjustable spacing of the plurality of rollers.

32. The modular curved conveyor of claim 31, wherein a spacing between a center of each roller is variable between about 3 inches and 6 inches.

33. A modular conveyor system comprising:
a table frame comprising:
two rails, each rail comprising:
a sidewall comprising a first plurality of through holes and a second plurality of through holes; and
a bottom wall comprising a fourth plurality of through holes; and
at least one cross-tie removably coupled between the two rails by fasteners provided through the first plurality of through holes; and
a plurality of rollers, each roller comprising a first axle end and a second axle end, the first axle end and the second axle end configured to be received by the second plurality of through holes; and
a H-stand comprising:
two uprights coupled together by two cross-beams; and
two pivot brackets, each pivot bracket provided at the top of each of the two uprights and comprising a top portion with two or more through holes, the H-stand being coupled to the table frame by fasteners provided through the two or more through holes of the top portion of the two pivot brackets and corresponding through holes of the fourth plurality of through holes of each rail.

34. The modular conveyor system of claim 33, wherein the H-stand comprises two cross-beams.

35. The modular conveyor system of claim 34, wherein the two cross-beams are telescoping to allow for a width of the H-stand to be varied.

36. The modular conveyor system of claim 33, wherein each of the two cross-beams comprises an inner portion and an outer portion, wherein the inner portion is at least partially nested within the outer portion.

37. The modular conveyor system of claim 36, wherein the inner portion is coupled to the outer portion by five fasteners.

38. The modular conveyor system of claim 35, wherein the width of the H-stand is variable between a 15-inch configuration and a 24-inch configuration.

39. The modular conveyor system of any one of claim 33, wherein a height of each of the two uprights is adjustable between about 24 inches and 36 inches.

40. The modular conveyor system of any one of claim 33, wherein each of the two uprights comprises a bottom portion and a top portion, wherein the top portion is at least partially nested within the bottom portion.

41. The modular conveyor system of any one of claim 33, wherein each of the two pivot brackets comprises a curved slot hole to provide an adjustable angle between each pivot bracket and each of the two uprights.

42. The modular conveyor system of claim 33, wherein at least one of the first axle end or the second axle end of each roller is depressible into a body of the roller.

43. The modular conveyor system of claim 33, wherein the second plurality of through holes of the two rails provide for adjustable spacing of the plurality of rollers.

44. The modular conveyor system of claim 43, wherein a spacing between a center of each roller is variable between about 3 inches and 6 inches.

45. The modular conveyor of claim 43, wherein a spacing between a center of each roller is selectable between 3 inches, 4.5 inches, and 6 inches.

46. The modular conveyor system of claim 33, further comprising one or more guide rails.

47. The modular conveyor system of claim 46, wherein each of the two rails further comprises a top wall comprising a fifth plurality of through holes, and wherein one or more guide rails are fastened to the two rails by fasteners provided through the fifth plurality of through holes.

48. The modular conveyor system of claim 33, wherein a width of the at least one cross-tie is adjustable between about 15 inches and 24 inches.

49. The modular conveyor system of claim 33, wherein the sidewall of each of the two rails further comprises a third plurality of through holes, and wherein a channel connector is coupled to each rail by fasteners received through the third plurality of through holes to couple to two additional rails.

50. The modular conveyor system of claim 49, wherein the table frame formed by coupling the two rails to two additional rails has a capacity of up to about 1200 pounds without an additional H-stand provided at an intersection between the two rails to two additional rails.

51. The modular conveyor system of claim 49, wherein the two rails and two additional rails are each about 5 feet in length.
